(19) United States
(12) Patent Application Publication
(10) Pub. No.: US 2013/0200053 A1
(43) Pub. Date: Aug. 8, 2013

(54) LASER PROCESSING CONTROL METHOD

(71) Applicant: Evgueni Bordatchev, London (CA)

(72) Inventor: Evgueni Bordatchev, London (CA)

(73) Assignee: National Research Council of Canada, Ontario (CA)

(21) Appl. No.: 13/640,977

(22) PCT Filed: Apr. 12, 2011
(86) PCT No.: PCT/CA11/50194

§ 371 Date: Jan. 23, 2013

Related U.S. Application Data
(60) Provisional application No. 61/323,558, filed on Apr. 13, 2010.

(51) Int. Cl. B23K 26/00

(52) U.S. Cl. CPC B23K 26/0066
USPC 219/121.78

(57) ABSTRACT

A control system for controlling a laser machining/processing apparatus and uses two separate control modules, each of which operates interdependently with the other. A laser control module contains instructions for controlling the laser beam while a movement control module contains instructions for controlling the movement of the laser apparatus relative to a workpiece. The instructions in each module are executed in parallel and interdependently of the instructions in the other module. The laser control module controls the actions of the laser apparatus while, in parallel, the movement control module controls the relative movements and/or positioning of the laser beam relative to the workpiece. Again, in parallel, the laser control module continuously checks the actual position of the laser apparatus against the desired position where laser action should be executed and, if the difference between the actual and the desired positions are within a predetermined margin of error, the relevant laser action is executed.

### TECHNICAL FIELD

The present invention relates to control systems for computer numerically controlled (CNC) machine tools. More specifically, the present invention relates to methods and systems for controlling laser processing and laser-material interactions.

### BACKGROUND OF THE INVENTION

A laser processing machine is a complex opto-electro-mechanical system for the fabrication of parts and features using a laser-material interaction process. The laser fabrication process is an integration of at least two processes, the workpiece/laser beam motion and the laser-material interaction (which can be the removal, melting, or addition of material), and is based on the simultaneous functioning of at least two major system components—the motion system and the laser apparatus. The final geometry, accuracy, precision, and surface finish of fabricated parts depend on the performance of these system components as well as on their synchronous functioning and control aspects.

Laser processing technology incorporates a combination of the laser-material interaction process, the motion system, and the computer numerical control (CNC). During laser processing, laser beam and/or pulses are applied according to pre-programmed sequence of tool path movements which position the laser on the material for laser-material interactions such as laser material removal, laser material addition, laser welding, laser polishing, etc., etc. The laser processing of parts and features involves CNC control of multi-axis motions such as travel speed and tool path trajectory, laser on/off events, the control of laser parameters such as frequency of the laser pulses, focal spot diameter, pulse energy, beam mode characteristics, energy distribution, etc. Traditionally, CNC control executes each control action in a sequential manner, i.e. one action is executed after another. As an example, a CNC control system will command a specific element of a tool path trajectory (i.e. place the laser at a specific point on the tool path trajectory) and only after that will it send a command to turn the laser on or off. The sequential positioning actions for the tool path trajectory may include a large number of positioning movements involving a multiplicity of areas to be laser processed.

The CNC controller for controlling laser processing as a combination of workpiece motions and specific execution of laser actions decodes an input NC machining program and distributes a process related command (e.g. motion, laser, powder/gas delivery, etc.) for every interpolation period to a motion controller. Based on the distributed interpolation period command, the motion controller performs feedback-based control of position, speed and current to drive axis servomotors to move a workpiece. Between the above mentioned motion-related commands, the motion controller executes commands to control other process-related equipment (e.g., laser control unit, powder delivery system, etc.).

To fabricate a part or feature with a desired geometric quality, the actual laser processing should be performed as close as possible to the ideal/desired laser processing that corresponds to the implementation of at least two major conditions:
actual tool path trajectory should have minimal/limited deviations from the desired tool path trajectory (e.g. positioning and dynamic errors are within desired tolerances along the entire tool path trajectory)
steady laser material removal/addition process along the tool path motion (e.g. constant volume of material removed for a laser material removal process or constant volume of material added for laser material addition process)

The first condition, involving deviations between actual and desired tool path trajectories, is dependent upon the performance of the motion system. The motion system may consist of a motion table, motion controllers, motors, and position sensors. Therefore, in order to minimize actual deviations, correction of the actual tool path trajectory and a properly tuned control algorithm for the motion controller may be required.

The second condition, that of a steady laser material removal/addition/interaction process, is very hard to achieve because it depends on a variety of cross-dependent process parameters supplied by two independent sources—the motion system and the laser apparatus. As an example, in the case of a laser material removal process (laser machining), the volume of material removed is determined by laser related parameters (such as pulse energy, pulse duration, pulse repetition rate, etc.) and motion related parameters (such as travel velocity, acceleration/deceleration time, non-uniformity of motions, etc.). The volume of material removed may also be affected by several additional process parameters related to the optic laser beam delivery system (e.g. laser beam profile, focusing distance, etc.) in addition to the physical-chemical-mechanical properties of the machined material.

Among all these parameters, two parameters have significant variations during laser processing and therefore have a major influence on the geometric quality of the machine parts and features. These two are the actual tool path and the actual travel velocity. All other parameters are generally more stable during laser processing. Thus, synchronization between the actual laser apparatus performance and actual tool path trajectory and/or travel velocity can be critical for laser processing.

During CNC-based laser material processing, there are at least four major types of asynchronization (lag or lead) that are most critical with respect to accuracy, precision, and surface quality:
(I) time lag between the motion command supplied by the CNC-controller and the motor being actually driven to move the workpiece to reach a target position
(II) time lag in reaching/maintaining a desired speed and therefore positional deviation in position control by the motion controller due to acceleration/deceleration of actual motions
(III) time lag and/or lead and therefore positional deviation in position control by the motion controller due to non-uniformity of actual motions and dynamic performance of the motions systems (e.g. under and/or over shoot)
(IV) time lag between receipt of a command by the laser oscillator and the actual laser output due to actual functioning of the laser oscillator

Therefore, parts and features fabricated by the laser processing process always have geometric inaccuracies in order of tens micrometers due to deviations in above mentioned synchronizations of actual motions and laser control commands in time and space.

There have been other attempts to alleviate these issues with machining and they include Japanese Patent 7223085, U.S. Pat. No. 6,570,121, U.S. Pat. No. 7,012,215, U.S. Pat. No. 7,370,796. However, none of these attempts have been completely successful.

### SUMMARY OF INVENTION

The present invention relates to computerized numerical control machines. The present invention provides a control system for controlling a laser machining/processing apparatus and uses two separate control modules, each of which operates interdependently with the other. A laser control module contains instructions for controlling the laser beam while a movement control module contains instructions for controlling the movement of the laser apparatus relative to a workpiece. The instructions in each module are executed in parallel and interdependently of the instructions in the other module. The laser control module controls the actions of the laser apparatus while, in parallel, the movement control module controls the relative movements and/or positioning of the laser beam relative to the workpiece. Again, in parallel, the laser control module continuously checks the actual position of the laser apparatus against the desired position where a laser action should be executed and, if the difference between the actual and the desired positions are within a predetermined margin of error, the relevant laser action is executed.

In one aspect, the present invention provides a system for controlling a laser processing apparatus, said laser machining apparatus comprising laser means for machining a workpiece using a laser beam and movement means for moving said laser beam relative to said workpiece, the system comprising data processing means for executing in parallel computer readable and computer executable instructions in a laser control module and a movement control module, said laser control module having instructions comprising:

a) determining a plurality of laser action locations where at least one laser action for said laser means is supposed to occur and determining what at least one laser action is supposed to occur at each one of said plurality of laser action locations
b) determining a current position of said laser beam relative to said workpiece
c) comparing said current position with at least one of said plurality of laser action locations determined in step a)
d) in the event a difference between said current position and said at least one laser action locations is within a predetermined acceptable range, based on determinations in step a), executing said at least one laser action for said corresponding laser action location through said laser means
e) repeating steps b)-d) for each laser action location and each laser action determined in step a)
said movement control module having instructions comprising:
f) determining a sequence of a plurality of movement action locations where motion change actions are supposed to occur
g) sequentially controlling said movement means to position said laser beam relative to said workpiece at each one of said plurality of movement action locations
wherein said laser control module and said movement control module continuously exchange data to execute steps a)-g).

In a second aspect, the present invention provides a method for controlling a laser processing apparatus, said laser machining apparatus comprising laser means for machining a workpiece using a laser beam and movement means for moving said laser beam relative to said workpiece, said method comprising:

a) determining a plurality of laser action locations where at least one laser action for said laser means is supposed to occur and determining what at least one laser action is supposed to occur at each one of said plurality of laser action locations
b) determining a current position of said laser beam relative to said workpiece
c) comparing said current position with at least one of said plurality of laser action locations determined in step a)
d) in the event a difference between said current position and said at least one laser action location is within a predetermined acceptable range, based on determinations in step a), executing said at least one laser action for said corresponding laser action location through said laser means
e) repeating steps b)-d) for each laser action and each laser action location determined in step a)
f) in parallel with steps a)-e), executing steps g)-h)
g) determining a sequence of a plurality of movement action locations where motion change actions are supposed to occur
h) sequentially positioning said laser beam relative to said workpiece at each one of said plurality of movement action locations.

### BRIEF DESCRIPTION OF THE DRAWINGS

The invention will be described with reference to the accompanying drawings, wherein

FIG. 1 is a block diagram of a control mechanism according to the prior art;

FIG. 2 is an illustration of a desired tool path trajectory and an actual tool path trajectory obtained using the prior art;

FIG. 3 is a picture of the results of laser machining using the prior art;

FIG. 4 is a diagram illustrating the shortcomings of using the prior art;

FIG. 5 is a block diagram of a control scheme according to one aspect of the invention;

FIG. 6 is an illustration of the desired tool path trajectory and the actual tool path trajectory obtained using one aspect of the invention;

FIG. 7 is a picture of the results of laser machining using one aspect of the invention;

FIG. 8 is a diagram illustrating the dimensions of the resulting workpiece using one aspect of the invention;

FIG. 9 is a flowchart illustrating the steps in a method according to one aspect of the invention.

### DETAILED DESCRIPTION OF THE INVENTION

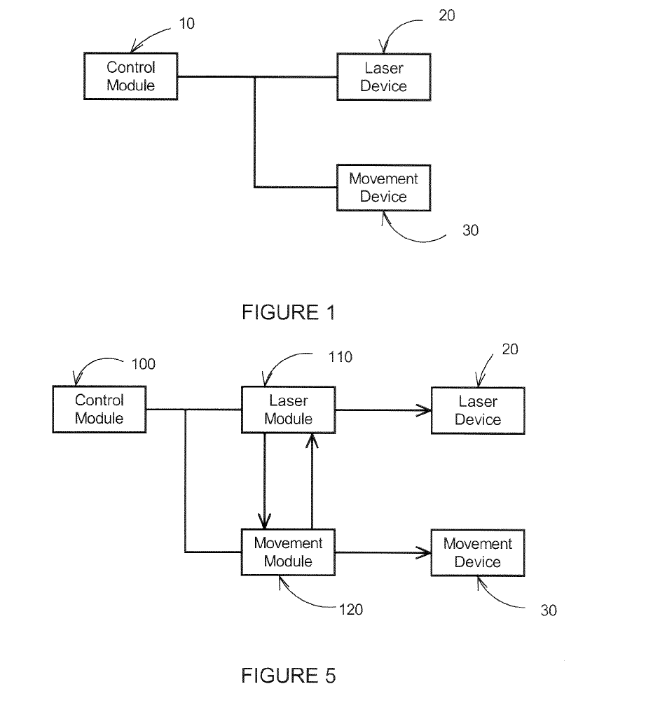

Referring to FIG. 1, a block diagram of a control mechanism for a laser machining apparatus according to the prior art is illustrated. A control module 10 sends out instructions to a laser hardware device 20 and to a movement hardware device 30. As is well-known, the laser hardware device 20 includes the laser itself along with suitable control circuitry. The movement hardware device 30 includes circuitry and hardware components for moving the laser and/or its laser beam focus relative to the workpiece being worked on. As the movement hardware device moves the laser's focus relative to the workpiece (or moves the workpiece relative to the laser's focus), features are processed on the workpiece and/or portions of the workpiece are removed, added, or changed.

The control mechanism illustrated in FIG. 1 has the control module executing instructions for both the laser hardware device and the movement hardware device sequentially. As such, the instructions for the two devices are mixed with one another. As noted above, this arrangement may cause overshoots and undershoots due to the lag between the receipt and execution of commands sent to either of the hardware devices.

This issue arises partly because all modern machining methods are based on conventional CNC approach in which a process control program contains a desired tool path trajectory in terms of G-codes, e.g., G0, G1, G2, G3, X, Y, Z, R, I, J etc, and specific commands for machining actions in terms of M-codes, e.g., M3, M4, M5 etc. For conventional machining these actions are turn spindle on/off, rotate tool holder, etc. Technologies, such as laser micromachining, laser consolidation, laser welding, laser drilling, laser polishing, etc., inherited the CNC approach, and therefore, programs associated with above mentioned processes control G/M-codes, also include basic laser control actions, such as, turn laser on/off, etc. However, there are significant negative consequences of the application of the conventional CNC approach to control the laser processing in terms of accuracy, precision and geometrical quality of parts and features, mostly associated with the sharp corners, deep cavities at the start and at the end points of motions due to the laser on/off actions and acceleration and deceleration of motions, which create major challenges in laser processing. The solution from conventional machining (e.g. in milling operation, while a cutting tool rotates, motion stops at a certain point, changes direction, and continues movement), is not suitable during high-precision laser processing, simply because the laser will continue to fire pulses causing unnecessary material removal and additional heating of the workpiece (in the case of laser micromachining). During acceleration/deceleration time segments, consecutive laser pulses were located very close to each other, and therefore, the workpiece material absorbs more laser energy per square unit, resulting in large amount of material removal. This is because of lack of synchronization between the motion and laser pulses to provide a constant overlap between each consecutive pulse. Also, the accuracy of corners was highly dependent on proper synchronization of motions with respect to part geometry. Conventional CAD/CAM software programs do not provide advanced options to correct this issue.

As an example of this issue, a sample CNC process control code is provided below with comments as to which actions are movement actions and which actions are laser actions:

| M4==1 | ; send digital output “1” |
|---|---|
| INC | ; incremental coordinates |
| G1 X0.2 Y0.2 | ; initial move (movement action) |
| M4 | ; turn laser ON (laser action) |
| G1 X1 | ; bottom horizontal line (movement |
| | action) |
| G1 Y1 | ; right vertical line (movement |
| action) | |
| G1 X-1 | ; top horizontal line (movement |
| action) | |
| G1 Y-1 | ; left vertical line (movement |
| action) | |
| M5 | ; turn laser OFF (laser action) |
| G1 X-0.2 Y-0.2 | ; return to origin (movement action) |
| M4==0 | ; send digital output “0” |

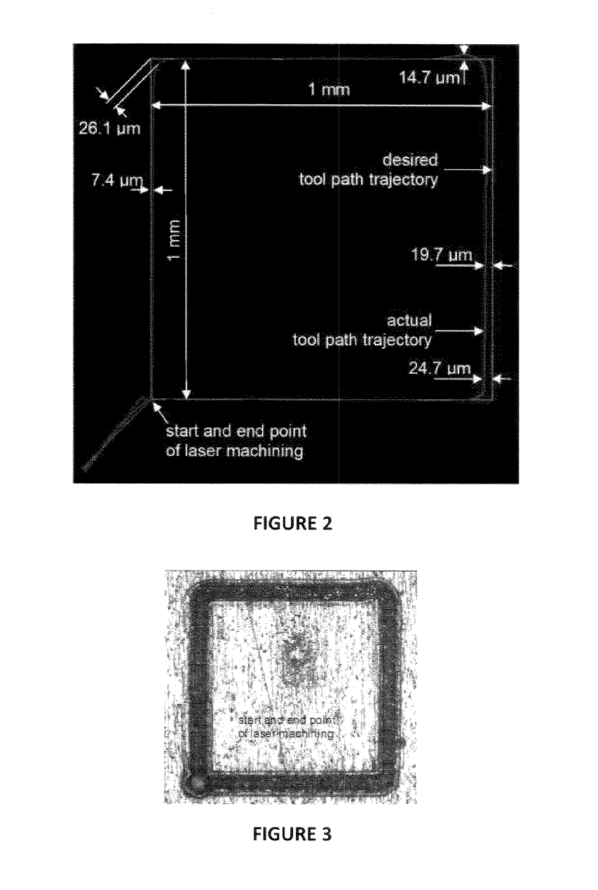

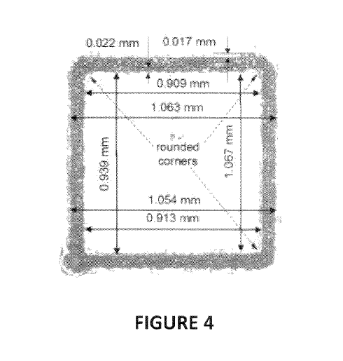

The results of using the above control code are illustrated in FIGS. 2-4. Analysis shows the actual tool path trajectory from executing the above code has significant dynamic errors due to agile motions at the corners. For example, a bottom right corner has an undershoot of 24.7 μm, top right corner has overshoot of 14.7 μm. These types of inaccuracies in the actual tool path trajectory (see FIG. 2) create substantial errors in the machined geometry (see FIG. 3). FIG. 3 shows the 1 mm square machined with the tool path trajectory using conventional CNC approach. FIG. 4 illustrates the dimensions of the features on the resulting workpiece.

This square has two critical inaccuracies:
a deep cavity at the start/end points and at the corners due to the combined effect of the laser on/off commands and acceleration and deceleration regimes, and
shape errors due to dynamic errors within the actual tool path trajectory shown in FIG. 2.

The present invention avoids the issues with the control scheme of the prior art by separating the control commands for the laser device and the movement device. The control commands for the two devices are executed separately but in parallel to one another. Thus, instead of a single execution thread for the laser machining apparatus as shown in the example above, two execution threads, executed concurrently, synchronously and in parallel, are used. It should be noted that the thread for the laser device does not contain any commands for the movement device and, similarly, the thread for the movement device does not have any commands for the laser device. Thus, the commands for one device can be executed in isolation from the commands of the other device. It should be noted, however, that the two execution threads are executed in a synchronized manner to each other.

Referring to FIG. 5, a block diagram of the control scheme according to one aspect of the invention is illustrated. A CNC control program module 100, which may be designed and executed according to well-known techniques, passes control of the laser device 20 and the movement device 30 to a laser module 110 and a movement module 120. The laser module 110 directly controls the laser device 20 while the movement module directly controls the movement device 30. Both modules 110, 120 are executed in parallel. However, these modules are operating synchronously to one another and are in communication with one another as they exchange data with each other.

The separation of the control of the laser device and the movement device prevents the undershoot and overshoot issues due to lag as mentioned above.

Another aspect of the invention involves the continual tracking of the position of the laser device (and/or the laser beam) relative to the workpiece being worked on. To ensure that the laser device is activated at the correct position, the laser module 110 continuously checks the actual position against the desired position before an action by the laser device is initiated. As part of this checking, position data between the movement module and the laser module may be continuously exchanged. Once the actual position is within an acceptable margin of error, the laser device action is initiated. The position checking can be done by simply subtracting the desired position from the actual position (or vice versa). Other ways of determining the difference between the two positions (the desired and the actual) may, of course, be used.

It should be noted that the laser action to be initiated at specific positions may be any action which affects the laser device. This may include turning on the laser, turning off the laser, adjusting a power of the laser (either increasing or decreasing the power), and changing the operational parameters of the laser device (e.g. diode current, pulse frequency, suppression time, etc.).

The above aspects of the invention can be seen in the sample instructions below for the laser module and the movement module. The instructions duplicate the results of the sample CNC process control code given above.

The instructions in the movement module are as follows:

| M4==1 | ; send digital output “1” |
|---|---|
| INC | ; incremental coordinate |
| G1 X0.2 Y0.2 | ; initial move |
| G1 X1.4 | ; bottom horizontal line |
| G1 X-0.2 Y-0.2 | |
| G1 Y1.4 | ; right vertical line |
| G1 X-0.2 Y0.2 | |
| G1 X-1.4 | ; top horizontal line |
| G1 X0.2 Y-0.2 | |
| G1 Y-1.4 | ; left vertical line |
| ABS | |
| G1 X0 Y0 | ; return to origin |
| M4==0 | ; send digital output “0” |

The instructions for the laser module are as follows below. It should be noted that the first column indicates the X coordinate of the laser action location, the second column indicates the Y coordinate of the laser action location, and the third column indicates the laser action. The comment regarding the instruction starts after the third column:

| | | | |
|---|---|---|---|
| 0.4 | 0.2 | 1 | ; start point of the bottom horizontal |
| | | | line, turn laser ON |
| 1.4 | 0.2 | 0 | ; end point of the bottom horizontal line, |
| | | | turn laser OFF |
| 1.4 | 0.2 | 1 | ; start point of the right vertical line, |
| | | | turn laser ON |
| 1.4 | 1.2 | 0 | ; end point of the right vertical line, |
| | | | turn laser OFF |
| 1.4 | 1.2 | 1 | ; start point of the top horizontal line, |
| | | | turn laser ON |
| 0.4 | 1.2 | 0 | ; end point of the top horizontal line, |
| | | | turn laser OFF |
| 0.4 | 1.2 | 1 | ; start point of the left vertical line, |
| | | | turn laser ON |
| 0.4 | 0.2 | 0 | ; end point of the left vertical line, |
| | | | turn laser OFF |

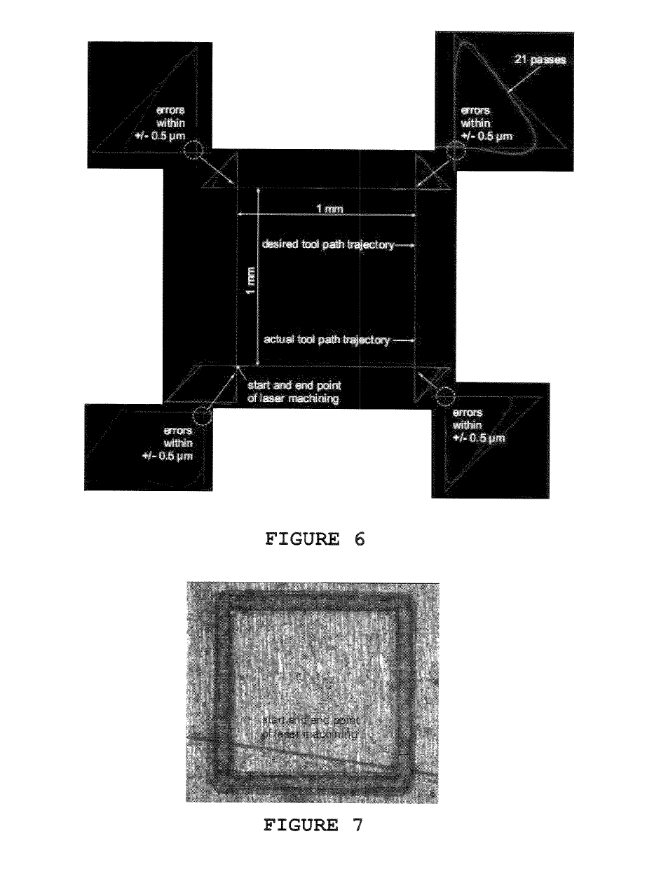

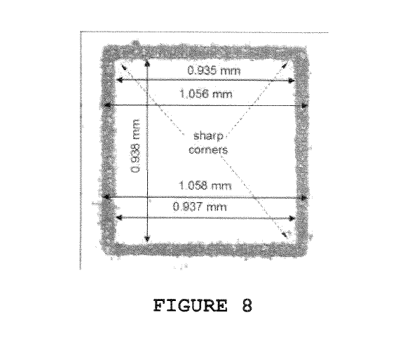

The results for the above instructions are shown in FIGS. 6-8. FIG. 6 shows the desired (in green) and actual (in red) tool path trajectories generated by the proposed approach. It is important to note that these tool path trajectories are modified at the corners, where agile motions generate significant dynamic errors. These modifications, called “over movements,” are known and in practice used in fabrication technologies, such as EDM machining. These additional “over movements” are intentionally introduced into the desired tool path trajectory to take agile motions outside the desired geometry. The dynamic errors still exist, but in this case they do not affect fabrication of the desired geometry. For laser processing, this approach provides an additional advantage, because the laser is off during “over movements” and therefore there is no laser-material interaction. Implementation of this approach allows achieving the difference of within +/−0.5 μm between actual and desired tool path trajectories corresponding to the desired geometry of the fabricated part (see FIG. 6). FIG. 7 illustrates the actual workpiece while FIG. 8 illustrates the dimensions of the features of the workpiece.

The actual tool path trajectory is also very repeatable. Corner accuracy was maintained to within +/−0.5 μm where 21 passes of the actual tool path trajectory were executed as shown in the top right corner of FIG. 6.

It should be noted that the above approach also extends the laser processing curve/line to thereby place the acceleration/deceleration section outside of the laser processing curve/line. This allows a constant travel velocity and removes the need for changing a laser output condition. In the sample control code provided above, the “over movements” allow the tool/laser device to have a constant velocity before any laser actions are executed. This is in contrast to the conventional approach where abrupt changes in travel velocity cause errors in the laser processing.

By recording the actual tool path trajectory with respect to time from the beginning of the process, this approach allows not just a positional accuracy but a temporal accuracy as well. If the movement module does not move the tool to a specified point within a given time frame, the laser module will not execute a specific laser action. This takes into account not merely the positional accuracy of the laser/tool but also whether the velocity and acceleration are within acceptable limits. The approach therefore not only checks whether the tool/laser positioning is within acceptable margins of error but also whether the arrival of the tool/laser is within a predetermined time window. The predetermined time window can be determined based on the projected travel velocity/parameters of the tool/laser.

A further refinement to the above would be to measure the time lag between the receipt of a command by the laser device (or oscillator) and the actual laser output due to the actual functioning of the laser oscillator. This can then be used to correct the laser module by taking into account the measured time lag. Of course, this lag would vary from machine to machine.

The various aspects of the invention significantly improve quality, accuracy and precision of the machined part. First of all, there is an absence of any sizeable deep cavities at the start/end points related to the laser on/off commands and acceleration and deceleration stages. All internal corners are sharp. The radius of the external corners is related only to the radius of the laser spot. All lines are straight and uniform. Deviations of the shape geometry are with +/−1 μm due to the dynamics of the laser material removal process and possible human related errors in optical measurements.

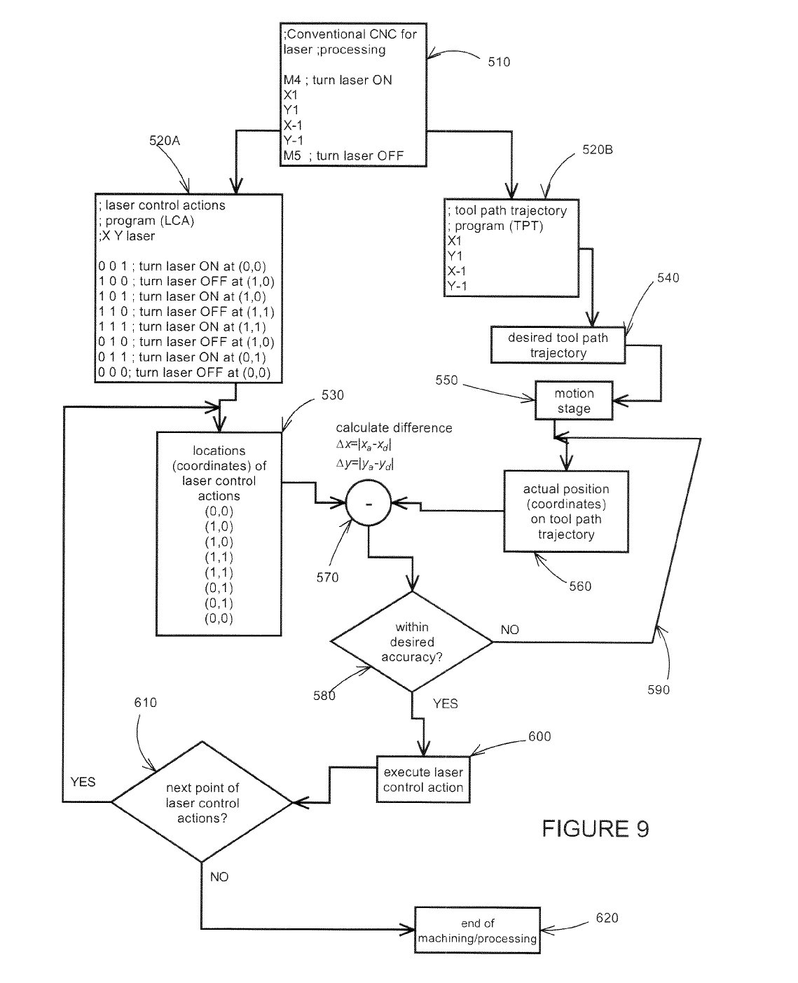

The logic of sample laser and movement modules is illustrated in FIG. 9. As can be seen, the initial CNC control program steps are taken at the topmost box 510.

Once these initialization steps have been taken, control is then passed to two parallel modules, the laser module (left 520A) and the movement module (right 520B). The instructions for these modules are illustrated as being inside their respective boxes in FIG. 9.

The movement module 520B moves the laser device's laser beam relative to the workpiece and traces a desired tool path trajectory. For the laser module 520A, the laser action locations where a laser action is to be performed are first determined (instructions in box 520A). These laser action locations are then continuously checked against the actual tool path trajectory (box 530). For the movement module, the waypoints on the actual tool path trajectory are read and plotted (box 540) and the tool is actually moved (box 550). The true coordinate position of the tool is then determined on the tool path trajectory (box 560) and these coordinates are subtracted from the coordinates where laser actions are to occur (operation 570). If the difference is not within a desired accuracy (via decision 580), then the logic for the movement module continues to move the laser tool (logic flow 590). If, on the other hand, the difference is within a desired accuracy, then the laser action is executed (box 600). The logic for the laser module then moves to the next laser action and determines if the coordinates for the next laser action are to be read (decision 610). If yes, then the logic loops back. If not, then the machining ends (box 620).

On-line monitoring of the actual tool path trajectory and the calculation of the difference in coordinates between desired/actual points at the laser control action provide synchronization of two parallel control streams, the movement module program and the laser module program, in time and space domains. The movement module executes the desired tool path trajectory only and does not include any laser control actions. The laser module is fully dedicated to the control of laser actions, both traditional “Laser ON/OFF” commands and control of another laser parameters. This approach sustains all the advantages of the conventional high-precision motion control as well as provides multi-functionality for laser control actions. In addition, the present invention offers two major advantages, which are not available in conventional CNC packages:
The possibility of synchronizing desired laser actions with respect to actual tool path trajectory and
The possibility of changing laser parameters “on-the-fly” in order to optimize and adapt process parameters with respect to actual processing conditions.

The method steps of the invention may be embodied in sets of executable machine code stored in a variety of formats such as object code or source code. Such code is described generically herein as programming code, or a computer program for simplification. Clearly, the executable machine code may be integrated with the code of other programs, implemented as subroutines, by external program calls or by other techniques as known in the art.

The embodiments of the invention may be executed by a computer processor or similar device programmed in the manner of method steps, or may be executed by an electronic system which is provided with means for executing these steps. Similarly, an electronic memory means such computer diskettes, CD-ROMs, Random Access Memory (RAM), Read Only Memory (ROM) or similar computer software storage media known in the art, may be programmed to execute such method steps. As well, electronic signals representing these method steps may also be transmitted via a communication network.

Embodiments of the invention may be implemented in any conventional computer programming language. For example, preferred embodiments may be implemented in a procedural programming language (e.g.“C”) or an object oriented language (e.g.“C++”). Alternative embodiments of the invention may be implemented as pre-programmed hardware elements, other related components, or as a combination of hardware and software components. Embodiments can be implemented as a computer program product for use with a computer system. Such implementations may include a series of computer instructions fixed either on a tangible medium, such as a computer readable medium (e.g., a diskette, CD-ROM, ROM, or fixed disk) or transmittable to a computer system, via a modem or other interface device, such as a communications adapter connected to a network over a medium. The medium may be either a tangible medium (e.g., optical or electrical communications lines) or a medium implemented with wireless techniques (e.g., microwave, infrared or other transmission techniques). The series of computer instructions embodies all or part of the functionality previously described herein. Those skilled in the art should appreciate that such computer instructions can be written in a number of programming languages for use with many computer architectures or operating systems. Furthermore, such instructions may be stored in any memory device, such as semiconductor, magnetic, optical or other memory devices, and may be transmitted using any communications technology, such as optical, infrared, microwave, or other transmission technologies. It is expected that such a computer program product may be distributed as a removable medium with accompanying printed or electronic documentation (e.g., shrink wrapped software), preloaded with a computer system (e.g., on system ROM or fixed disk), or distributed from a server over the network (e.g., the Internet or World Wide Web). Of course, some embodiments of the invention may be implemented as a combination of both software (e.g., a computer program product) and hardware. Still other embodiments of the invention may be implemented as entirely hardware, or entirely software (e.g., a computer program product).

A person understanding this invention may now conceive of alternative structures and embodiments or variations of the above all of which are intended to fall within the scope of the invention as defined in the claims that follow.

Having thus described the invention, what is claimed as new and secured by Letters Patent is:

1. A system for controlling a laser processing apparatus, said laser processing apparatus comprising laser means for machining a workpiece using a laser beam and movement means for moving said laser beam relative to said workpiece, the system comprising data processing means for executing in parallel computer readable and computer executable instructions in a laser control module and a movement control module, said laser control module having instructions comprising:
a) determining a plurality of laser action locations where at least one laser action for said laser means is supposed to occur and determining what at least one laser action is supposed to occur at each one of said plurality of laser action locations
b) determining a current position of said laser beam relative to said workpiece
c) comparing said current position with at least one of said plurality of laser action locations determined in step a)
d) in the event a difference between said current position and said at least one laser action locations is within a predetermined acceptable range, based on determinations in step a), executing said at least one laser action for said corresponding laser action location through said laser means
e) repeating steps b)-d) for each laser action location and each laser action determined in step a)
said movement control module having instructions comprising:
f) determining a sequence of a plurality of movement action locations where motion change actions are supposed to occur
g) sequentially controlling said movement means to position said laser beam relative to said workpiece at each one of said plurality of movement action locations
wherein said laser control module and said movement control module continuously exchange data to execute steps a)-g).

2. A system according to claim 1 wherein said laser action comprises at least one of:
activating said laser means
deactivating said laser means
changing an operating parameter of said laser means.

3. A system according to claim 1 wherein said instructions in said modules are executed independent of one another.

4. A system according to claim 1 wherein step d) includes the step of determining whether an arrival at said current position is within predetermined time constraints.

5. A system according to claim 4 wherein, in the event said arrival is not within said predetermined time constraints, said laser action is not executed.

6. A system according to claim 4 wherein, in the event said arrival is within said predetermined time constraints, said laser action is executed.

7. A method for controlling a laser processing apparatus, said laser machining apparatus comprising laser means for machining a workpiece using a laser beam and movement means for moving said laser beam relative to said workpiece, said method comprising:
a) determining a plurality of laser action locations where at least one laser action for said laser means is supposed to occur and determining what at least one laser action is supposed to occur at each one of said plurality of laser action locations
b) determining a current position of said laser beam relative to said workpiece
c) comparing said current position with at least one of said plurality of laser action locations determined in step a)
d) in the event a difference between said current position and said at least one laser action location is within a predetermined acceptable range, based on determinations in step a), executing said at least one laser action for said corresponding laser action location through said laser means
e) repeating steps b)-d) for each laser action and for each laser action location determined in step a)
f) in parallel with steps a)-e), executing steps g)-h)
g) determining a sequence of a plurality of movement action locations where motion change actions are supposed to occur
h) sequentially positioning said laser beam relative to said workpiece at each one of said plurality of movement action locations.

8. A method according to claim 7 wherein said laser action comprises at least one of:
activating said laser means
deactivating said laser means
changing an operating parameter of said laser means.

9. A system according to claim 7 wherein steps a)-d) are executed independent of steps f)-h).

10. A method according to claim 7 wherein step d) includes the step of determining whether an arrival at said current location is within predetermined time constraints.

11. A system according to claim 10 wherein, in the event said arrival is not within said predetermined time constraints, said laser action is not executed.

12. A system according to claim 10 wherein, in the event said arrival is within said predetermined time constraints, said laser action is executed.
